(19) United States
(12) Patent Application Publication
(10) Pub. No.: US 2009/0252072 A1
(43) Pub. Date: Oct. 8, 2009

(54) Method and Apparatus for Maintaining Long-Lived Connections Between a Mobile Client and a Server

(75) Inventors: Helena Lind, Sollentuna (SE); Mikael Lind, Sollentuna (SE); Andreas Ljunggren, Vallingby (SE)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 12/099,289

(22) Filed: Apr. 8, 2008

(51) Int. Cl. G08C 17/00

(52) U.S. Cl. 370/311

(57) ABSTRACT

A method and apparatus according to the present invention enables a mobile terminal in a mobile communication network to end a packet data session to save battery power while maintaining a long-lived TCP connection with a server in an external packet data network. The method comprises receiving a keep alive message from a server for a mobile client at a network node in the mobile communication network and, if there is no current packet data session between the mobile client and the network node, responding to the keep alive message on behalf of the mobile client to maintain a connection between the server and said mobile client. The apparatus comprises a GGSN or other network node in the mobile communication network configured to practice the method.

### BACKGROUND

The present invention relates generally to packet data communications over mobile communication networks and, more particularly, to a method and apparatus for maintaining a long-lived communication session between a mobile client and a server in a packet data network.

The introduction in recent years of packet data services for mobile subscribers has resulted in an explosion of wireless applications. Wireless device users are now able to access many of the services that have been commonly available in fixed networks for many years. For example, users can now use their mobile devices to access the Internet, download music files, send digital photographs or videos to friends, participate in instant message sessions, and send and receive email messages.

Certain IP-based services require that the mobile station always be on-line. An example of one such service is push email. Push email enables mobile subscribers to get immediate notification and access to new messages as they are received at the user's mailbox. Typically, the mobile station initiates a mail session with the mail server. The mail client on the mobile station can request the mail server to send unsolicited notifications to the mobile station whenever new mail messages arrive in the user's mailbox. As long as the session between the mail client and the mail server remains active, the mail server sends email notifications to the mobile station, typically within a few minutes following arrival of the new mail messages.

Existing mobile communication networks were designed without consideration of IP services utilizing long-lived TCP connection, such as push email and instant messaging. One problem that has not been addressed is the need for the mobile terminal to maintain connections with servers in the external networks. To confirm that an idle connection is still active, the mail server may send periodic “keep-alive” messages to the mail client. The “keep-alive” message triggers an acknowledgement from the mail client confirming that the connection is still live. The periodic “keep alive” message and the acknowledgement also serve to keep a Network Address Translation (NAT) session for the mobile terminal active if the traffic traverses a NAT gateway. If the mobile client fails to responds to a predetermined number of consecutive keep-alive messages, the mail server may terminate the connection. After a predetermined time-out period, the NAT session will also be terminated. One disadvantage of this approach is that the mobile station power is drained, even when there is no data to send to the mobile station, because the mobile station must respond to the keep-alive messages in order to maintain its connection with the server.

### SUMMARY

The present invention allows the mobile terminal to deactivate a PDP context when an associated client application is inactive for a predetermined period of time in order to save battery power. The PDP context may be subsequently reactivated by either the mobile terminal or the network when there is data to send. When the PDP context is deactivated and a mobile client on the mobile terminal has an active connection with a server in an external packet data network, a network node in the mobile communication network is configured to respond to a keep alive message from an external server on behalf of the mobile client in order to maintain the connection. The deactivation and reactivation of the packet data session may be totally transparent to the mobile client and the server. The present invention is useful to maintain long-lived connections for services such a push email, instant messaging, and presence services.

### BRIEF DESCRIPTION OF THE DRAWINGS

FIG. 1 illustrates an exemplary mobile communication network.

FIG. 2 illustrates an exemplary procedure for mobile initiated PDP context activation.

FIG. 3 illustrates an exemplary procedure for maintaining long-lived connections between a mobile client and a server.

FIG. 4 illustrates an exemplary GGSN configured to respond to keep-alive message on behalf of a mobile client.

FIG. 5 illustrates an exemplary network initiated PDP context activation procedure.

FIG. 6 illustrates an exemplary mobile communication network in an alternate embodiment of the invention.

### DETAILED DESCRIPTION

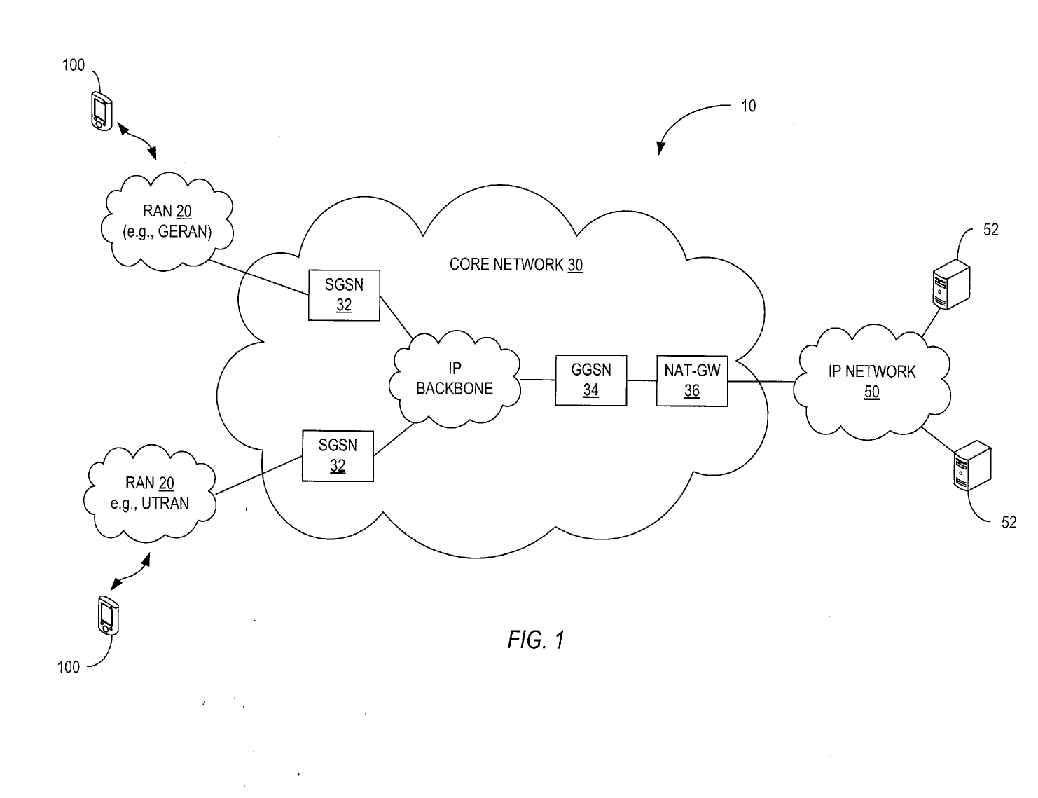

Referring now to the drawings, FIG. 1 illustrates an exemplary mobile communication network, indicated generally by the numeral 10, in which the present invention may be utilized. For illustrative purposes, the exemplary mobile communication network 10 comprises a UMTS network, however those skilled in the art will appreciate that the present invention may be applied with equal utility in other mobile communication networks that operate according to other standards, e.g., GSM/EDGE networks, WCDMA networks and OFDM networks.

Mobile communication network 10 comprises a radio access network (RAN) 20 and a core network (CN) 30. RAN 20 supports radio communications with mobile terminals 100 over an air interface. The mobile terminals 100 may comprise, for example, mobile telephones, personal digital assistants (PDAs), laptop computers, and other mobile computing devices. The mobile communication network 10 typically includes multiple RANs 20 though only two are shown in FIG. 1. The CN 30 provides a connection to the Internet 50 or other external packet data network (PDN) for packet switched services such as web browsing and email, and may provide a connection to the Public Switched Telephone Network (PSTN) and/or the Integrated Digital Services Network (ISDN) for circuit-switched services such as voice and fax services. The CN 30 in the exemplary communication network 10 comprises a UMTS core network having one or more Serving GPRS Support Nodes (SGSNs) 32 and one or more Gateway GPRS Support Nodes (GGSNs) 34. The SGSN 32 is responsible for the delivery of data packets from and to the mobile terminals 100 within its geographical service area. Its tasks include packet routing and transfer, mobility management (attach/detach and location management), logical link management, and authentication and charging functions. The GGSN 34 is a network node that acts as a gateway between the mobile communication network 10 and external packet data networks 50, such as the Internet.

In some embodiments, communication network 10 may further include a Network Address Translation (NAT) gateway 36 to perform network address translation. NAT is a technique that allows multiple network devices to share the same network address. Because the number of IPv4 addresses is limited, a NAT gateway 36 is frequently used in mobile communication networks 10. Typically, NAT is session based, which means that address translation is performed by the NAT gateway 36 for all packets in a given session (e.g., TCP session, UDP session, etc.) rather than on individual packets. This approach ensures that address translation is performed consistently on all packets in a given session. Upon detection of a TCP flow or other data flow, a NAT session is established to perform address translation. Normally, the NAT session will time-out after a predetermined time period (e.g., 15 minutes) when the TCP connection is idle. While the NAT gateway 36 is shown separately in the drawings, those skilled in the art will appreciate that the diagram represents a logical architecture and that the function of the NAT gateway 36 may be incorporated into the GGSN 34.

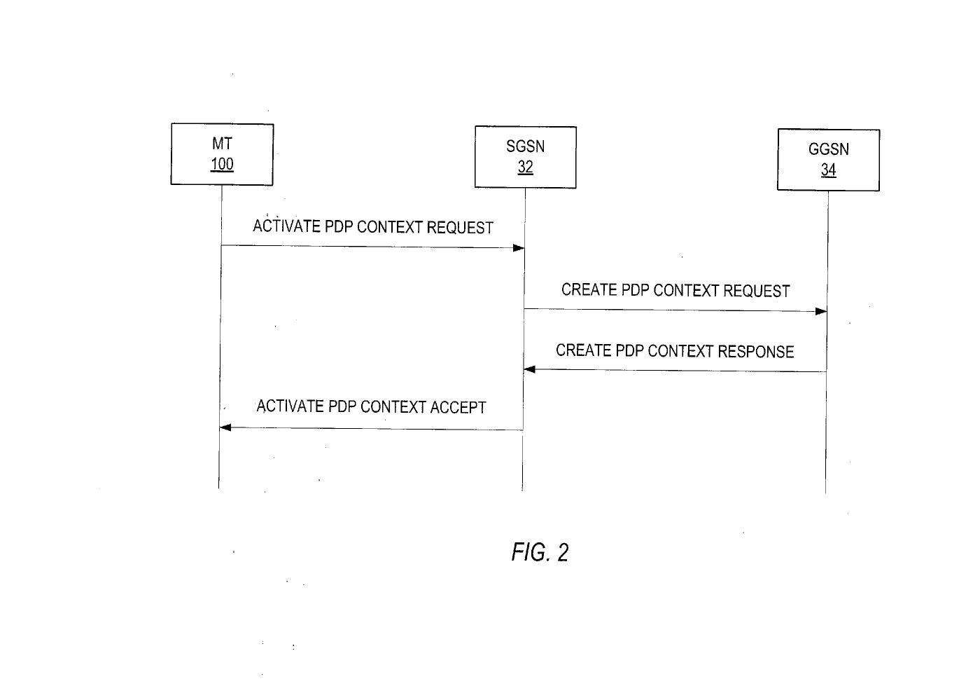

The mobile communication network 10 enables mobile clients hosted on mobile terminals 100 to access external packet data networks 50, such as the Internet. In order for the mobile client to access to external packet data networks 50, the mobile terminal 100 needs to establish a packet data protocol (PDP) context (also known as a packet data session). FIG. 2 illustrates an exemplary mobile terminal initiated context activation procedure. When a mobile client needs access to an external packet data network 50, the mobile terminal 100 sends an “Activate PDP context” request including an access point name to the serving SGSN 32. The SGSN 32 resolves the access point name to identify a GGSN 34 and sends a “Create PDP Context” request to the selected GGSN 34. The GGSN 34 or other network entity assigns a network address, such as an IP address, to the mobile terminal 100 and sends a “Create PDP Context” response to the SGSN 32. The SGSN 32 in turn sends an “Activate PDP Context Accept” response to the mobile terminal 100 to confirm PDP context activation.

Once a PDP context is activated, a mobile client on the mobile terminal 100 may be used to browse the web, send and receive emails, chat with friends, receive RSS feeds, and perform many other activities as if the mobile terminal 100 were attached to a fixed network. Some services may require that the mobile terminal 100 be “always connected.” An example of one such service is push email. Depending upon the implementation, the mobile terminal 100 may need to maintain a TCP connection with a mail server in order to receive unsolicited, i.e., push, email. For example, in implementations of push email based on the Internet Messaging Application Protocol, Version 4 (IMAP4), the mobile terminal 100 may send the mail server an IMAP IDLE command (RFC 2177) to indicate that the mail client residing on the mobile terminal 100 is ready to accept unsolicited emails. The IMAP IDLE command allows the mail client on the mobile terminal 100 to receive immediate mailbox updates without the need to poll the mail server as long as it maintains a TCP connection with the mail server.

From the perspective of the mail server, intermittent connectivity of mobile terminals 100 may be a problem. The mobile terminal 100 may lose service or may be turned off by the user without terminating the TCP connection with the mail server. In order to free unused resources, the mail server may terminate the TCP connection when the TCP connection is inactive for a long period of time. The mail server may monitor the TCP connection by periodically sending a probe to the mail client on the mobile client when the connection is otherwise idle to confirm that an idle connection is still live. The periodic probe, sometimes referred to as a “keep alive” message, causes the mail client on the mobile terminal 100 to return an acknowledgement confirming that the connection is still live. If the mobile client fails to responds to a predetermined number of consecutive keep-alive messages, the mail server may terminate the connection. The periodic “keep alive” message also serve to keep a NAT session for the mobile terminal 100 active if the traffic traverses a NAT gateway 36.

Existing mobile communication networks were designed without consideration of IP services utilizing long-lived TCP connection, such as push email and instant messaging. One problem that has not been adequately addressed is the need for the mobile terminal 100 to maintain an active PDP context in order to respond to periodic “keep-alive” messages from a server 52 in an external packet data network 50. As noted above, the “keep-alive” messages may be used to maintain an active connection with the mail server, instant message server, or other server 52, as well as to maintain an active NAT session in the NAT gateway 36. Maintaining the PDP context and responding to “keep alive” messages drains the battery of the mobile terminal 100 even when no user data is transmitted.

According to one embodiment of the present invention, the GGSN 34, SSGN 32, or other network node in the mobile communication network 10 is configured to respond to “keep alive” messages on behalf of the mobile terminal 100 to maintain an active TCP connection between a mobile client and a server 52 in an external packet data network 50 while allowing the mobile terminal 100 to terminate the PDP context in order to save battery power. The GGSN 34 or other network node is further configured to reactivate a PDP context when data for the mobile terminal 100 arrives from the external packet data network 50. The GGSN 34, SSGN 32, or other network node may temporarily store data for the mobile terminal 100 while the new PDP context is activated. Further, a mechanism is provided to make sure that the mobile terminal 100 gets the same network address when the PDP context is reactivated.

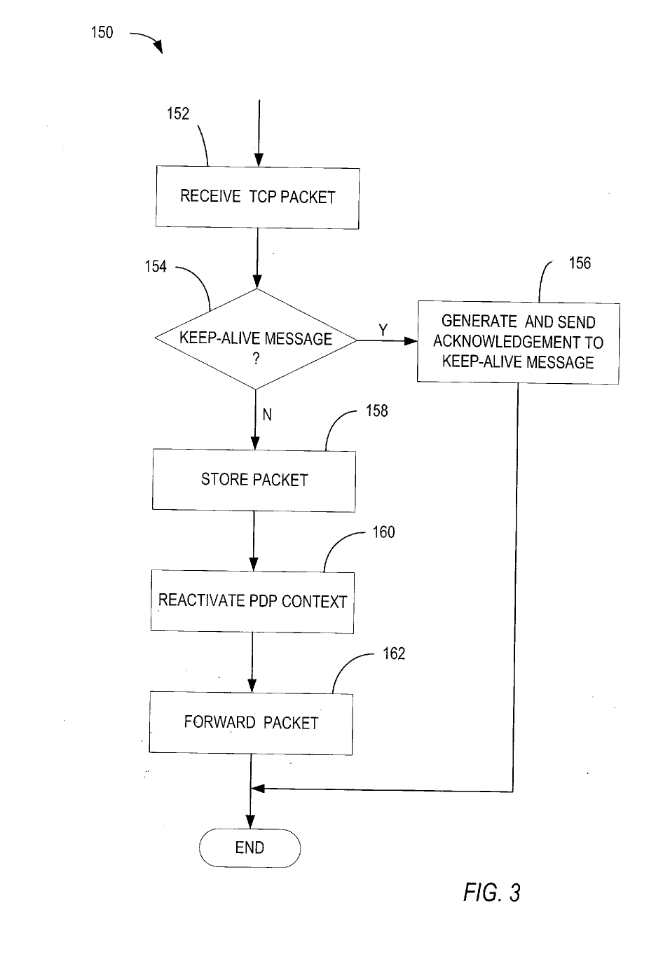

FIG. 3 illustrates and exemplary procedure 150 implemented by the GGSN 34 for maintaining a connection between a mobile client and a server 52 when the mobile terminal has deactivated the packet data session with the GGSN 34. The GGSN 34 receives a TCP packet from the external network 50 (block 152). After receiving the packet, the GGSN 34 determines whether the TCP packet is a “keep alive” message (block 154). If so, the GGSN 34 generates and sends an acknowledgement for the “keep alive” message to the server that originated the “keep alive” message (block 156). If not, the GGSN 34 temporarily stores the packet in memory (block 158) and reactivates the PDP context with the mobile terminal 100 (block 160). After the PDP context is reactivated, the packet is forwarded to the mobile terminal 100 (block 162). Those skilled in the art will appreciate that the method shown in FIG. 3 may be performed by a processor in the GGSN 34 or other network node executing instructions stored in a computer readable medium, such as a read-only memory (ROM), random access memory (RAM), magnetic or optical disk, or a removable memory device.

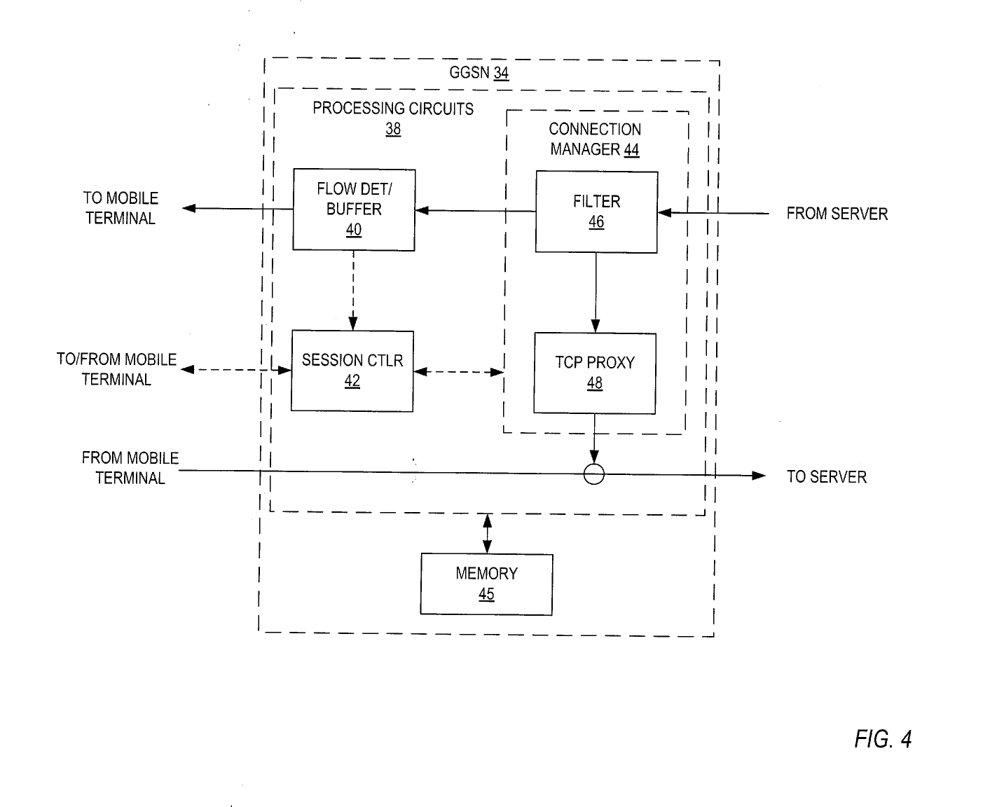

FIG. 4 illustrates the main functional components of an exemplary GGSN 34 configured to practice the above-described method. In the exemplary embodiment, the main functional components are embodied in processing circuits 38, which may comprise one or more processors, hardware circuits, or a combination thereof, and memory 45, which stores instructions and data for carrying out the functions of the GGSN 34. The processing circuits 38 comprise a flow detector/buffer 40, a session controller 42, and a connection manager 44. The flow detector/buffer 40 detects the arrival of packets for a mobile terminal 100 from external packet data networks 50 and temporarily stores the data in memory (not shown) at the GGSN 34 if there is no current packet data context established with the mobile terminal 100. The session controller 42 is responsible for establishing, modifying, and terminating PDP contexts with the mobile terminal 100. The session controller 42 is also responsible for storing state information relating to the PDP context. The connection manager 44 is responsible for maintaining an active TCP connection on behalf of a client that has an active TCP connection with a server 52 in the external packet data network but has no active PDP context with the GGSN 34.

The connection manager 44 includes a packet filter 46 to filter packets arriving from external packet data networks 50, and further includes a TCP Proxy 48. The packet filter 46 examines TCP packets arriving from the external packet data networks 50 and separates TCP “keep alive” messages from other TCP packets. The TCP “keep alive” messages are redirected to the TCP Proxy 48, which may be allocated to the mobile client/mobile terminal 100 from a pool of TCP Proxies 48. The TCP Proxy 48 is configured to generate and send a response to the TCP “keep alive” message. From the perspective of the server 52, it will appear as if the mobile client in the mobile terminal 100 acknowledged the “keep alive” message and the TCP connection will be maintained. Both the “keep alive” message and the response will also traverse the NAT gateway 36 which will further maintain the NAT session at the NAT gateway 36.

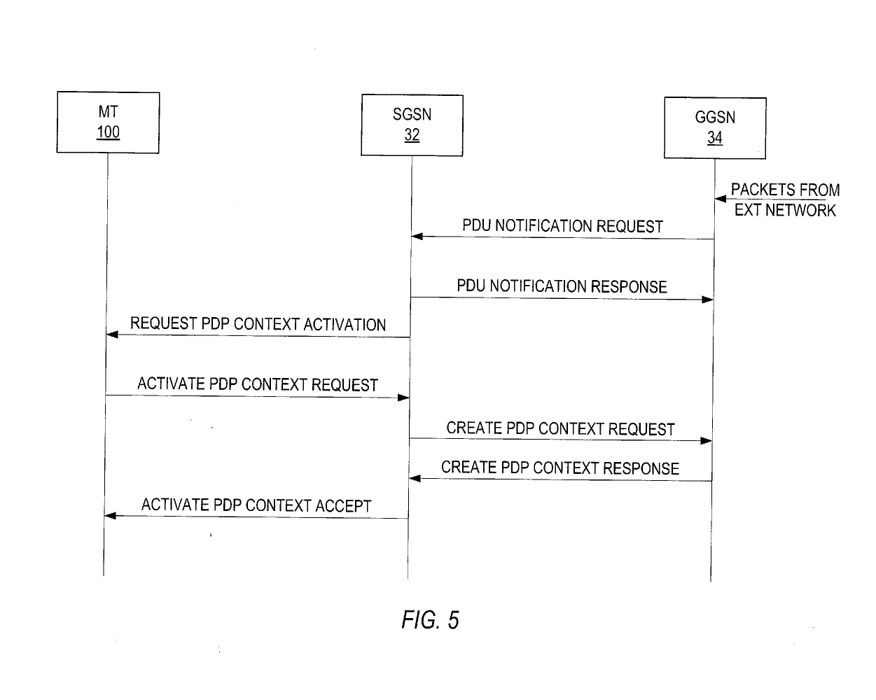

When user data for the mobile client other than a keep alive message arrives at the GGSN 34 from an external network, the PDP context needs to be reactivated in order to deliver the data to the mobile client. FIG. 5 illustrates an exemplary network-initiated PDP context activation procedure. When the GGSN 34 receives packets from the external network, it sends a “PDU Notification” request to the SGSN 32 currently serving the mobile terminal 100. The SGSN 32 acknowledges the “PDU Notification” request by sending a “PDU Notification” response. The SGSN 32 sends a “Request PDP Context Activation” request to the mobile terminal 100 to trigger the PDP context activation. The remaining actions are identical to the mobile-initiated PDP context activation. Specifically, the mobile terminal 100 sends an “Activate PDP Context” request to the SGSN 32. In response to the “Activate PDP Context” request, the SGSN 32 sends a “Create PDP Context” request to the GGSN 34. The GGSN 34 allocates resources for the new PDP context and sends a “Create PDP Context” response to the SGSN 32. If the GGSN 34 is reactivating a previously-established PDP context, it will need to assign the mobile terminal 100 the same network address. After receiving the “Create PDP Context” response from the GGSN 34, the SGSN 32 sends an “Activate PDP Context Accept” response to the mobile terminal 100 to confirm reactivation of the PDP context. The GGSN 34 may then forward the data stored in the buffer to the mobile terminal 100.

To implement the invention, a mechanism needs to be devised to ensure that the mobile terminal 100 is allocated the same network address (e.g., IP address) when it is reactivating a PDP context. One way of ensuring the same network address is allocated is to maintain a list of reserved network addresses at the entity that allocates network addresses. When a mobile terminal 100 terminates a PDP context, it may transmit and indication to the GGSN 34 to indicate that a long-lived TCP connection is active. In this case, the session controller 42 at the GGSN 34 or other entity may mark the current network address as reserved. When a PDP context is activated/reactivated, the session controller 42 or AAA server may first check the reserved address list to determine whether a reserved address exists for the mobile terminal 100. If so, the reserved address is allocated. If not, the network address may be allocated in a conventional fashion.

Those skilled in the art will recognize that there may be scenarios in which the the function of responding to keep-alive messages on behalf of the mobile terminal is located at an SGSN 32 or other network node. In the home network, the GGSN 34 typically serves as the anchor point for the mobile terminal and therefore is a logical location for this function. In a visited network, the SGSN 32 or other network node may serve as the anchor node. Therefore, the function of responding to keep alive messages may be located at the SGSN 32 or other network node in the visited network. The method shown in FIG. 3 can be implemented using the DCCP and SCTP.

The present invention allows the mobile terminal 100 to inactivate a PDP context when the associated application is inactive for a predetermined period of time. The deactivation and reactivation may be totally transparent to the mobile client and the server 52. When the PDP context is deactivated while the mobile client has an active TCP connection, the session controller 42 at the GGSN 34 may release the network and radio resources used to tunnel data between the mobile client and the GGSN 34. Both the mobile terminal 100 and the session controller 42 may, however, store some session parameters so that the session may be reactivated at a later time. While the PDP context is deactivated, the GGSN 34 or other network node may detect TCP keep-alive messages from the server 52 and respond on behalf of the mobile client to maintain the TCP connection with the server 52. When the mobile client attempts to send data to the server 52, the mobile terminal 100 may reactivate the PDP context, e.g., establish a new connection with the GGSN, with only a small delay. Similarly, when data arrives at the GGSN 34 from the server 52, the GGSN 34 may initiate PCP context reactivation.

The present invention enables mobile terminals 100 to maintain a long-lived TCP connection without having to maintain an active PDP context with the GGSN 34. This allows the mobile terminal 100 to conserve battery power and avoids NAT traversal problems. The present invention may be conveniently used to provide push email, instant messaging, and other services requiring long-lived TCP connection.

While an embodiment of the invention using the TCP protocol has been described, those skilled in the art will appreciate that other embodiments may use connection-oriented protocols such as the Stream Control Transmission Protocol (SCTP), Datagram Congestion Control Protocol (DCCP), or other connection-oriented transport protocols. These other protocols also have a keep-alive mechanism similar, so TCP. For example, SCTP includes an explicit keep alive message to monitor idle connections. Also, DCCP allows zero-length data packets to be used as keep-alive messages. Depending on the protocol used, the packet filter can be configured to detect keep alive messages for these protocols.

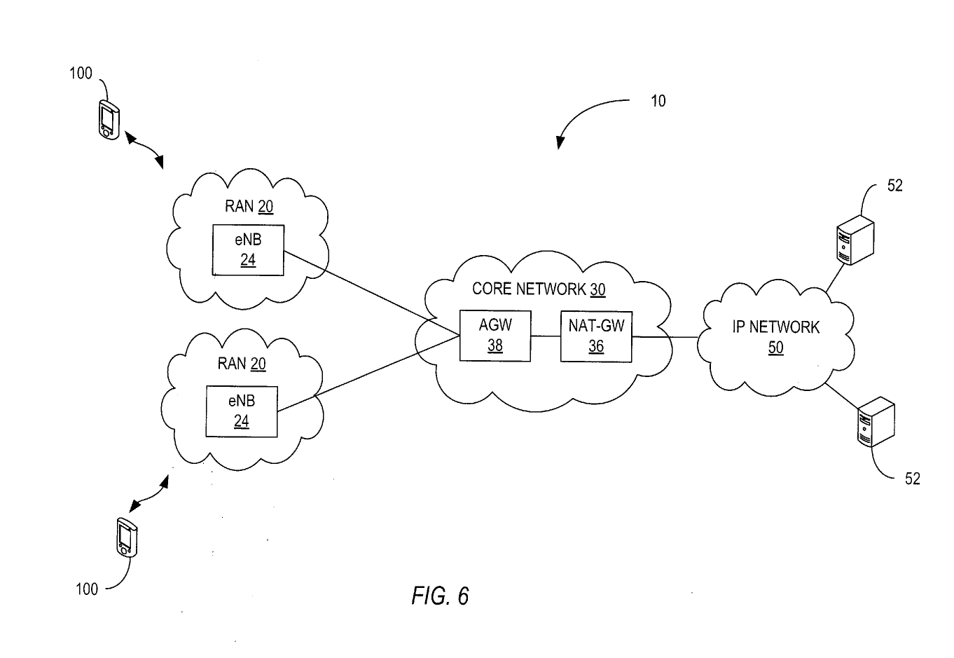

The embodiment described is based on the UMTS system architecture. Other embodiments of the present invention may use a different network architecture, such as the System Architecture Evolution (SAE) network architecture proposed by the Third Generation Partnership Project (3GPP). FIG. 6 illustrates another exemplary communication network 10 based on the SAE architecture. For convenience, the reference numbers used to identify elements in this embodiment are the same as the previous embodiment where the elements are the same. In this embodiment, the communication network 10 comprises an Evolved Radio Access Network (Evolved RAN) 20 and an Evolved Core Network (CN) 30. The Evolved RAN 20 includes a single type of node; the Evolved NodeB (eNodeB) 24. Similarly, the CN 30 includes a single type of node referred to herein as the Access Gateway (AGW) 38. In this embodiment, the function of responding to keep-alive messages may be located at the AGW 38. Thus, the AGW 38 may be configured substantially as shown in FIG. 4 and perform the method illustrated in FIG. 3.

The embodiments shown and described are intended to be illustrative of the invention. The present invention can also be easily adapted for other network architectures now known or later developed by those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of maintaining a connection between a mobile terminal in a mobile communication network and a server in an external packet data network, said method comprising:
receiving at a network node in the mobile communication network a keep alive message from said server intended for said mobile terminal; and
if there is no active packet data session for the mobile terminal, responding to said keep alive message on behalf of said mobile terminal to maintain a connection between said mobile terminal and said server.

2. The method of claim 1 further comprising filtering packets received at said network node to detect said keep alive messages.

3. The method of claim 1 further comprising reactivating an inactive packet data session for said mobile terminal when user data arrives at said network node for said mobile terminal.

4. The method of claim 3 further comprising temporarily storing data for said mobile terminal at said network node while said packet data session is reactivated.

5. The method of claim 3 wherein reactivating the inactive packet data session comprises reactivating the inactive packet data session using an network address reserved for said mobile terminal when data arrives at said network node for said mobile terminal.

6. The method of claim 1 implemented by a Gateway GPRS Support Node in a GPRS or UMTS core network.

7. The method of claim 1 implemented by a Serving GPRS Support Node in a GPRS or UMTS core network.

8. The method of claim 1 implemented by a Access Gateway in an SAE Evolved Core Network.

9. A network node in a mobile communication network configured to maintain a connection between a mobile terminal in a mobile communication network and a server in an external packet data network, said network node comprising:
a packet filter to detect a keep-alive message from said server to said mobile terminal; and
a proxy to respond to said keep alive message on behalf of said mobile terminal.

10. The network node of claim 9 further comprising a session controller to reactivate an inactive packet data session for said mobile terminal when data arrives at said network node for said mobile terminal.

11. The network node of claim 10 further comprising temporary data storage for storing data for said mobile terminal at said network node while said packet data session is reactivated.

12. The network node of claim 11 wherein the session controller reactivates the inactive packet data session using a network address reserved for said mobile terminal.

13. The network node of claim 9 wherein the network node is a Gateway GPRS Support Node in a GPRS or UMTS core network.

14. The network node of claim 9 wherein the network node is a Serving GPRS Support Node in a GPRS or UMTS core network.

15. The network node of claim 9 wherein the network node is an Access Gateway in an SAE Evolved Core Network.

16. A computer readable medium having instructions stored therein for execution by a processor to cause a network node in a mobile communication network to perform a method comprising:
receiving at a network node in the mobile communication network a keep alive message from an external server intended for a mobile terminal in said mobile communication network; and
if there is no active packet data session for the mobile terminal, responding to said keep alive message on behalf of said mobile terminal to maintain a connection between said mobile terminal and said server.

17. The computer readable medium of claim 16 wherein the method further comprises filtering packets received at said network node to detect said keep alive messages.

18. The computer readable medium of claim 16 wherein the method further comprises reactivating an inactive packet data session for said mobile terminal when user data arrives at said network node for said mobile terminal.

19. The computer readable medium of claim 18 wherein the method further comprises temporarily storing data for said mobile terminal at said network node while said packet data session is reactivated.

20. The computer readable medium of claim 18 wherein the method further comprises reactivating the inactive packet data session comprises reactivating the inactive packet data session using an network address reserved for said mobile terminal when data arrives at said network node for said mobile terminal.

21. The computer readable medium of claim 16 wherein the instructions cause a Gateway GPRS Support Node in a GPRS or UMTS core network to perform said method.

22. The computer readable medium of claim 16 wherein the instructions cause a Serving GPRS Support Node in a GPRS or UMTS core network to perform said method.

23. The computer readable medium of claim 16 wherein the instructions cause an Access Gateway in an SAE Evolved Core Network to perform said method.
